(19) United States
(12) Patent Application Publication
(10) Pub. No.: US 2019/0180920 A1
(43) Pub. Date: Jun. 13, 2019

(54) Ground Protection Coil

(71) Applicant: PE Manufacturing Company of Florida, St. Petersburg, FL (US)

(72) Inventor: Kenneth M. Elder, Largo, FL (US)

(73) Assignee: PE Manufacturing Company of Florida, St. Petersburg, FL (US)

(21) Appl. No.: 15/839,562

(22) Filed: Dec. 12, 2017

(51) Int. Cl. H01F 27/28; H01F 17/06; H01F 27/00; H01F 27/38

(52) U.S. Cl. CPC H01F 27/2823; H01F 17/062; H01F 2005/027; H01F 27/38; H01F 27/006

(57) ABSTRACT

A ground protection coil for insertion into a circuit includes an inner coil section consisting of a wire wound in a first direction for a first number of turns and an outer coil section consisting of the wire wound in a second direction for a second number of turns. The second direction is at an angle of approximately 90 degrees from the first direction.

### FIELD

This invention relates to the field of surge suppression and more particularly to a coil to protect a circuit from surges.

### BACKGROUND

Sudden power surges caused by lightning or equipment malfunction often causes failure of circuits and equipment due to power surges. Equipment located in the vicinity of the cause of the surge is often destroyed, especially sensitive equipment such as cable repeaters. Many such equipment are often protected from surge entering on power inputs and on signal inputs/outputs, but not from surges entering on ground lines (earth ground).

Lightning often strikes trees, the ground, and other objects such as power lines. Lightning protection currently covers structural protection as well as electrical power protection on the power and data lines. Structural protection is commonly known as a “lightning rod” system that provides lightning strike current a safe, low resistance path to ground (earth ground). The “lightning rod” system is typically provided to prevent structural fires as the building structure itself is often a high resistance path to ground and large lightning currents cause heat and, therefore, fire.

Surge protection is currently provided to protect electrical power and data communication lines. Surge protection devices attempt to block or mitigate surges entering a building from the incoming metallic conductors (power and data).

For both lightning rod systems and for power surge protection devices to provide protection, the energy from a lightning strike must hit either the structure or the incoming metallic lines.

There is another path for surge damage that has not been considered. Surges from nearby lightning strikes, for example, enter through the earth ground. In the literature any voltage appearing in the earth is known as “ground potential” and if there is a sudden change in voltage of the ground, it is called a “ground potential rise.” There have been many studies of ground potential rise and it is known that ground potential rise can cause surge damage similar to a direct lightning strike.

Inductive coils have been used in electrical grounding systems in the past. In particular a Peterson grounding coil has been used to ground electrical utility power transformer secondary windings. The Peterson coil was introduced and studied extensively in the 1920's and 1930's. Because the Peterson coil affects system voltage balance and fault currents, use was discontinued in electric utility practice.

One of the issues with any inductive coil is the effects the coil can have on an electrical system due to the coil's inductance at the 60 cycle power line frequency.

What is needed is a grounding protection coil that exhibits almost zero inductance at the 60 cycle power system frequency and, therefore, has little effect on the electric power system.

### SUMMARY

In one embodiment, a ground protection coil for insertion into a circuit is disclosed including an inner coil section consisting of a wire wound in a first direction for a first number of turns and an outer coil section consisting of the wire wound in a second direction for a second number of turns. The second direction is at an angle of approximately 90 degrees from the first direction.

In another embodiment, a method of protecting an electrical device from ground surges is disclosed including installing ends of a temporary electrical jumper on a ground path that provides a ground potential to the electrical device at a location of installation of a ground protection coil then cutting the ground path between the ends of a temporary electrical jumper. Next, the ground protection coil is electrically connected into the ground path where the ground path was cut and then the temporary electrical jumper is removed. The ground protection coil includes an inner coil section consisting of a wire wound in a first direction for a first number of turns and an outer coil section consisting of the wire wound in a second direction for a second number of turns, the second direction being rotated 90 degrees from the first direction.

In another embodiment, a ground protection coil is disclosed including a first winding being a first serpentine printed circuit path running in a first direction for a first number of turns and a second winding consisting of a second serpentine printed circuit path running in a second direction for a second number of turns. The second direction is at an angle of approximately 90 degrees from the first direction.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of an inner coil section of the ground protection coil.

FIG. 2 illustrates a perspective view of an outer coil section of the ground protection coil.

FIG. 3 illustrates a perspective view of the ground protection coil.

FIG. 4 illustrates a perspective view of the ground protection coil fabricated as paths on a printed circuit board.

FIG. 5 illustrates a plan view of an exemplary ground circuit for a cable television distribution amplifier of the prior art.

FIGS. 6-8 illustrate plan views of an installation of the ground protection coil in the ground circuit for a cable television distribution amplifier.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Any coiled wire of sufficient length will have inductance. The inductance will vary with the number of turns of wire in the coil. Current flowing through a coil of wire will create an electrical field. Each turn of wire has a field that affects nearby turns of wire. These fields slow the flow of current through the coiled wire. When a coil is wound over an iron core, the field magnetizes the core and the inductance is higher. Losses in the coil result in heating of the coil and core. Therefore, a typical iron core inductor must be made very large in order to carry a high load current without overheating.

Without the iron core, only the magnetic fields resist current flow and those fields are not nearly as strong as magnetic fields in a coil having an iron core. When used on alternating current power systems, coreless coils can carry much more current without overheating than similar size coils having iron cores.

Unfortunately due to the small fields, prior coreless coils are not useful for surge protection as they do not reduce surge levels significantly.

U.S. Pat. No. 7,085,115 for “non-ferrous surge balancing coil” describes a pair of coils placed such that the windings were located 90 degrees to each other. This surge balancing coil was designed to be used in electrical power and data systems where each opposed winding of the coil is independent and connected to a different power conductor.

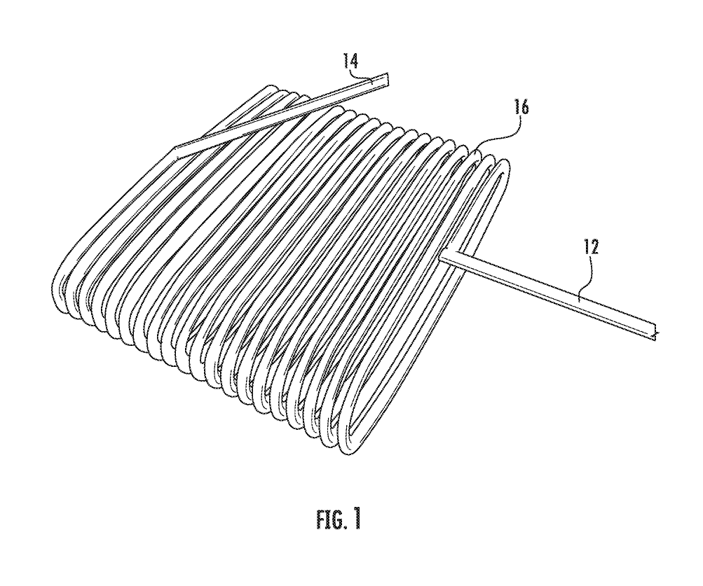

The ground protection coil 10 (see FIGS. 1-4) is a single conductor coil using the 90 degree winding style used typically in the application of a grounding coil. The 90 degree windings of the ground protection coil 10 are applied to an electrical grounding path, thus the ground protection coil 10 is wound from a single electrical conductor in the 90 degree winding style.

This ground protection coil 10 provides resistance to sudden changes of ground current attempting to enter the power system through an electrical grounding path, while providing low resistance to lower frequency changes (e.g. DC to 60 Hz).

In some applications, two or more ground protection coils 10 are inserted into power lines to reduce the passage of transient surge spikes.

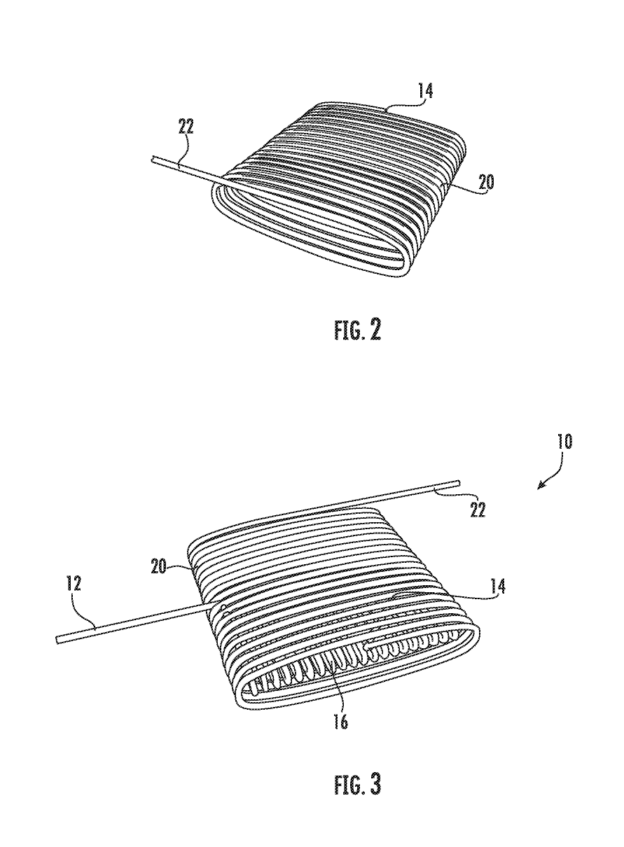

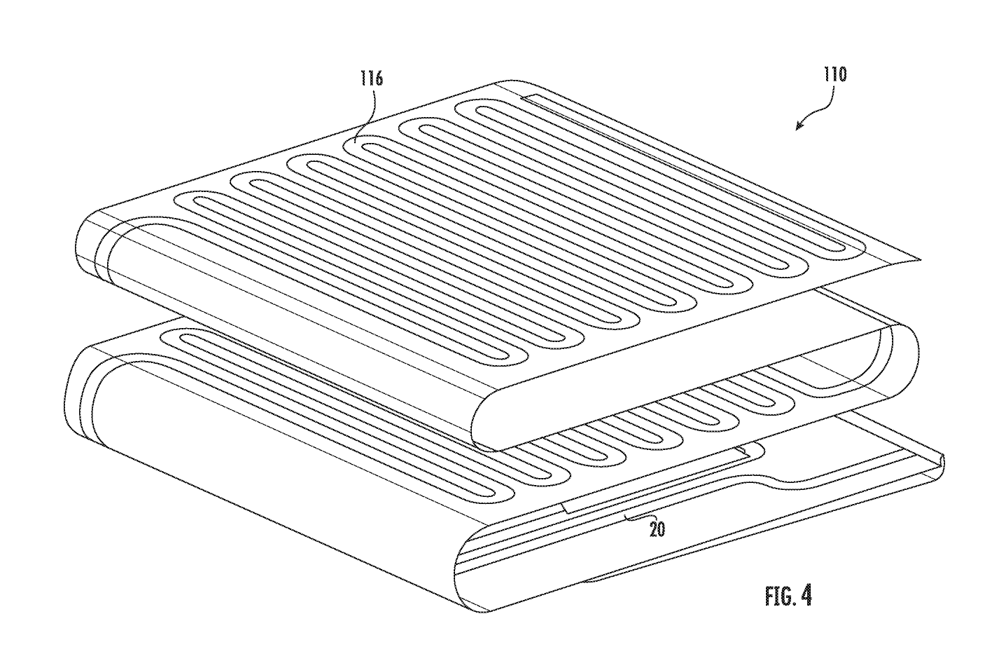

Referring to FIGS. 1, 2, and 3, perspective view of the ground protection coil 10 are shown. The ground protection coil 10 as shown in FIG. 3 comprises an inner coil section 16 having a single input lead 12 as shown in FIG. 1 and an outer coil section 20 as shown in FIG. 2. The windings of the inner coil section 16 are substantially at right angles to the windings of the outer coil section 20. There is an intermediate connecting wire 14 that connects the inner coil section 16 to the outer coil section 20. The outer coil section 20 has a single output lead 22.

In some embodiments the inner coil section 16 and the outer coil section 20 are made from a single, continuous wire. In some embodiments the inner coil section 16 is wrapped in one direction, then the inner coil section 16 is rotated 90 degrees and the outer coil section 20 is wrapped over the inner coil section 16. The wire size/gauge and number of turns is dependent upon the amount of current carrying capacity needed. For example, for a 15 amp load, at least a 14 gauge wire size is required.

The coil is typically manufactured by winding wire on a coil form. Typically 3 turns of wire or more are wound, though it has been shown as few as 3 turns work although somewhat weakly and that more than 20 turns has diminishing returns due to the cost of wire (e.g. copper wire).

In some embodiments, the inner coil section 16 has the same number of turns as the outer coil section 20. For example, if the inner coil section 16 has 20 turns, then the outer coil section 20 will also have 20 turns. In some embodiments, the inner coil section 16 has a different number of turns as the outer coil section 20. For example, if the inner coil section 16 has 20 turns, then the outer coil section 20 has some number of turns other than 20.

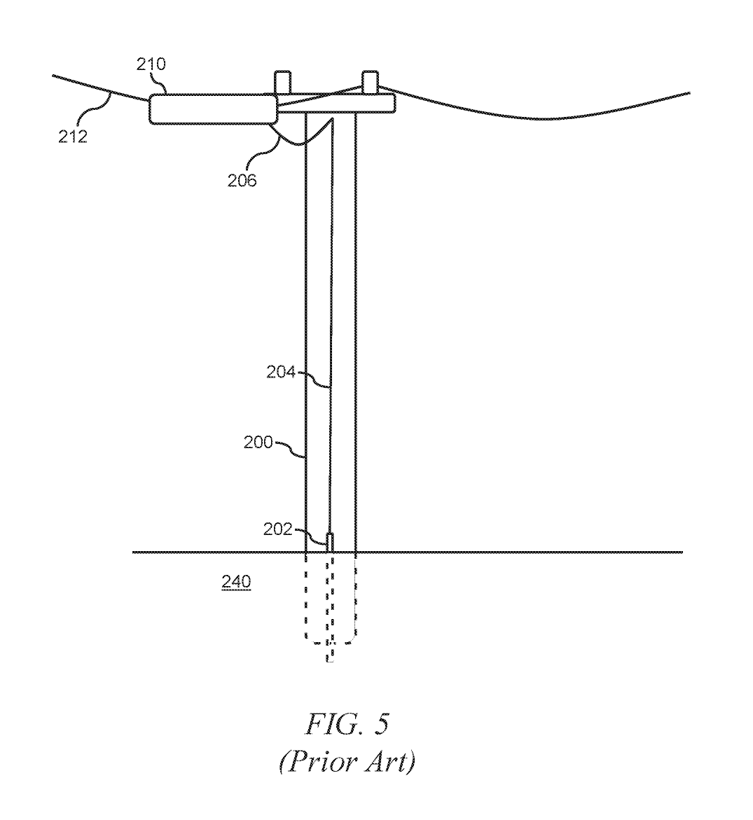

Referring to FIG. 4, a perspective view of the ground protection coil 10 fabricated as paths on a printed circuit board 110. The field interaction is created by circuit paths on the printed circuit board(s) 110 being formed in a serpentine fashion as shown in FIG. 4. The ground protection coil 10 is fabricated as part of the printed circuit board 110, eliminating the need for winding coils of wire.

In one embodiment, multiple printed circuit board(s) 110 with are stacked with serpentine circuit traces 116 on each printed circuit board 110 running at 90 degrees with respect to serpentine circuit traces 116 on the adjacent printed circuit board 110. One printed circuit board 110 has an input connector and another has an output connector.

In another embodiment, printed circuit board(s) 110 are made with serpentine circuit traces 116 on one side of the printed circuit board 110 running at 90 degrees with respect to serpentine circuit traces 116 on the opposing side of the printed circuit board 110. One side of the printed circuit board 110 has an input connector at a first end of the serpentine circuit trace 116 on that side, the other side of the printed circuit board 110 has an output connector a first end of the serpentine circuit trace 116 on that side, and there is a through-board connection (via) between the second end of both serpentine circuit traces 116.

In another embodiment, printed circuit board(s) 110 are made with serpentine circuit traces 116 on multiple layers of the printed circuit board 110 running at 90 degrees with respect to serpentine circuit traces 116 on other layers of the printed circuit board 110. One layer of the printed circuit board 110 has an input connector at a first end of the serpentine circuit trace 116 on that layer, another layer of the printed circuit board 110 has an output connector a first end of the serpentine circuit trace 116 on that layer, and there is a through-layer connections (via) between the second end of both serpentine circuit traces 116. Multiple are anticipated, but a minimum of 4 layers is preferred. In the example shown in FIG. 4, a flexible printed circuit board 110 is shown with serpentine circuit traces 116 and the flexible printed circuit board 110 is folded over itself to place alternating serpentine circuit traces 116 next to each other.

Referring to FIG. 5, a plan view of an exemplary ground circuit for a cable television distribution amplifier 210 of the prior art. This circuit is shown as an example of one application that is in need of the ground protection coils 10, as many other applications are anticipated. In the prior art, a cable television distribution amplifier 210 is located in line with a cable 212 (e.g. for cable television and Internet), typically strung between telephone poles 200. A ground wire 204 often runs down the telephone pole 200 and the ground wire 204 is attached to a lightning rod 202 that is installed into the earth 240, deep enough as to provide a solid earth ground. In the prior art, if lightning strikes the ground near the lightning rod 202, a surge of electrical energy often travels up the ground wire 204 and destroys the sensitive circuitry within the cable television distribution amplifier 210.

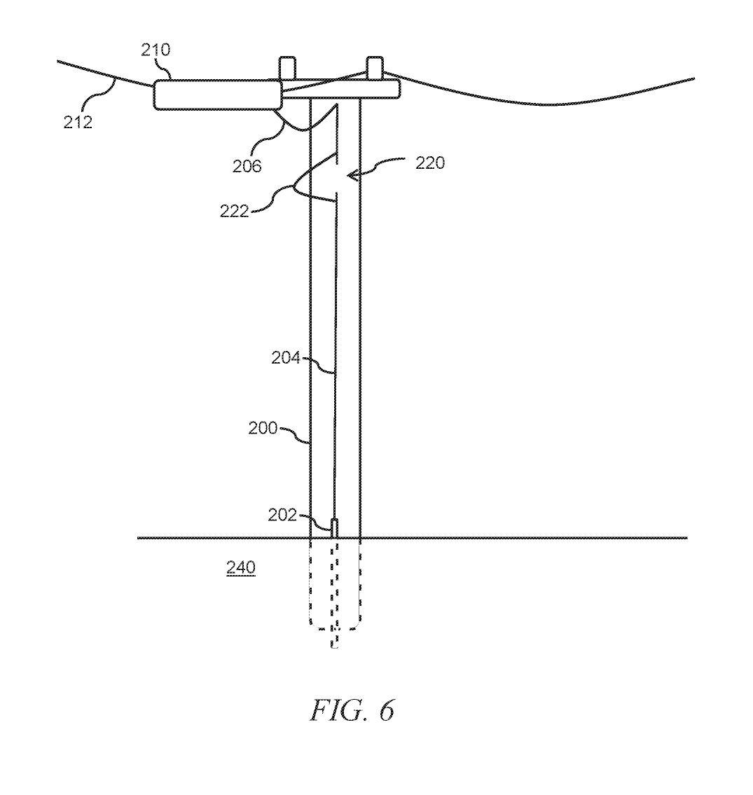

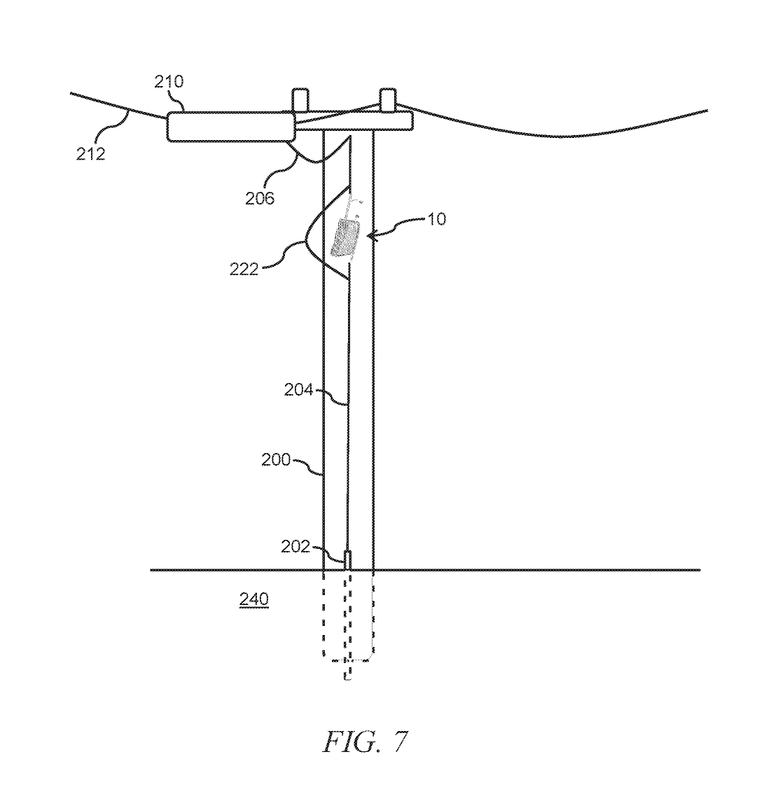

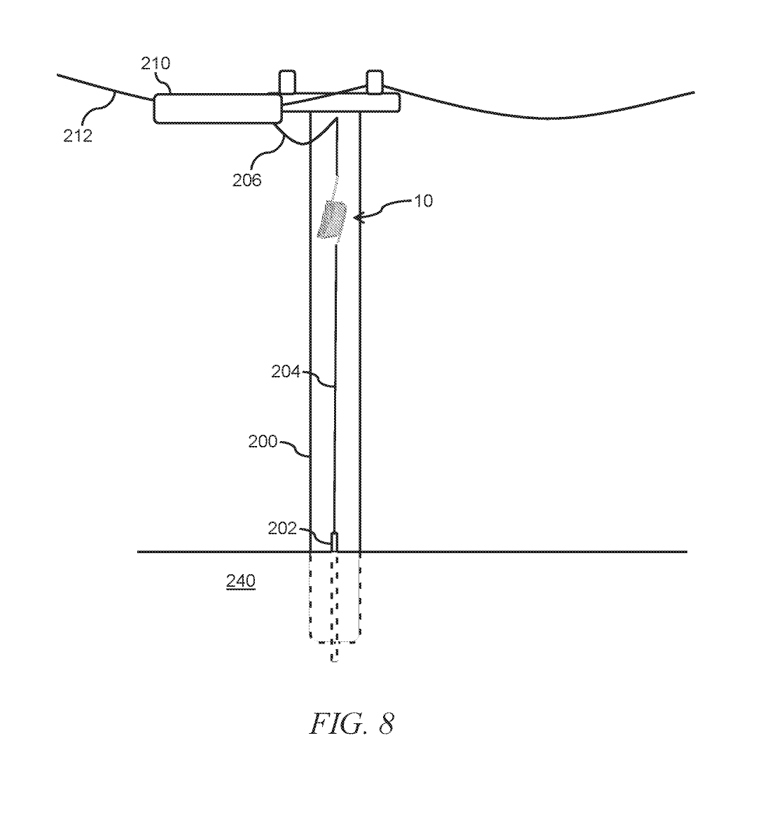

Referring to FIGS. 6-8, plan views of a method of installation of the ground protection coil 10 in the ground circuit using a cable television distribution amplifier 210 as an example. The ground protection coil 10 is installed in series with the existing ground wire 204. To install the ground protection coil 10, the ground wire is cut and the ground protection coil 10 is inserted and bonded to the cut ends of the ground wire 204. As shown in FIG. 6, so as to not interrupt operation of the electrical device being protected (e.g. the cable television distribution amplifier 210), a jumper wire 222 is installed onto the ground wire 204 at a point 220 where the ground protection coil 10 is to be inserted. The ground wire 204 is then cut.

As shown in FIG. 7, the ground protection coil 10 is then installed in series with the ground wire 204 and, after the ground protection coil 10 is then installed in series with the ground wire 204, the jumper wire 222 is removed as the ground protection coil 10 will now carry any load. Although the ground protection coil 10 is shown being installed, it is anticipated that protection coils of other geometry with or without metal cores are installed in the ground circuit in a similar fashion to reduce surges emanating from the earth during various events such as lightning strikes, transformer failures, power line failures, etc.

It should be noted that it is anticipated that the ground protection coil 10 will be used to protect many devices other than the cable television distribution amplifier 210 that is shown as an example.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A ground protection coil consisting of:
an inner coil section consisting of a wire that is wound in a first direction for a first number of turns; and
an outer coil section consisting of the wire that is wound in a second direction for a second number of turns;
whereas the second direction is at an angle of approximately 90 degrees from the first direction.

2. The ground protection coil of claim 1, wherein the ground protection coil is inserted in a circuit between an electrical device and ground potential.

3. The ground protection coil of claim 1, wherein the first number of turns is the same as the second number of turns.

4. The ground protection coil of claim 1, wherein the first number of turns is different from the second number of turns.

5. The ground protection coil of claim 1, wherein the wire is a path of a printed circuit board.

6. A method of protecting an electrical device from ground surges, the method comprising:
installing a first end of an electrically conducting jumper on a first location of a ground path that provides a ground potential to the electrical device;
installing a second end of the electrically conducting jumper on a second location of a ground path;
cutting the ground path into two segments between the first location and the second location;
providing a ground protection coil consisting of:
an inner coil section consisting of a wire that is wound in a first direction for a first number of turns;
an outer coil section consisting of the wire wound in a second direction for a second number of turns;
whereas the second direction is at an angle of approximately 90 degrees from the first direction;
electrically connecting the ground protection coil into the ground path by connecting a first end of the wire of the ground protection coil to a first segment of the two segments and connecting a second end of the wire of the ground protection coil to a second segment of the two segments; and
removing the electrically conducting jumper.

7. (canceled)

8. The method of claim 6, wherein the first number of turns is the same as the second number of turns.

9. The method of claim 6, wherein the first number of turns is different from the second number of turns.

10. The method of claim 6, wherein the wire is a path of a printed circuit board.

11. The method of claim 6, wherein the ground path is a grounding wire running from a lightning rod to the electrical device, the lightning rod is sunk within the earth.

12. The method of claim 11, wherein the grounding wire runs up a side of a telephone pole.

13. The method of claim 6, wherein the electrical device is a cable television distribution amplifier.

14. A ground protection coil consisting of:
a first winding consisting of a first serpentine printed circuit path running in a first direction for a first number of turns;
an input lead connected to a first end of the first winding;
a second winding consisting of a second serpentine printed circuit path running in a second direction for a second number of turns, whereas a second end of the first winding is electrically connected to a second end of the second winding;
an output lead connected to a first end of the second winding;
whereas the second direction is at an angle of 90 degrees from the first direction.

15. The ground protection coil of claim 14, wherein the ground protection coil is inserted into a circuit between an electrical device and ground potential.

16. The ground protection coil of claim 14, wherein the first number of turns is the same as the second number of turns.

17. The ground protection coil of claim 14, wherein the first number of turns is different from the second number of turns.

18. The ground protection coil of claim 14, wherein the first serpentine printed circuit path is on a first side of a printed circuit board and the second serpentine printed circuit path is on a second side of the printed circuit board.

19. The ground protection coil of claim 14, wherein the first serpentine printed circuit path is on a first layer of a printed circuit board and the second serpentine printed circuit path is on a second layer of the printed circuit board.
